(19) United States
(12) Patent Application Publication
(10) Pub. No.: US 2003/0166296 A1
(43) Pub. Date: Sep. 4, 2003

(54) Chemical species analyzer

(76) Inventors: Roxane F. Morrison, Silverado, CA (US); Wayne B. Wood, Silverado, CA (US)

Correspondence Address: Christopher R. Christenson, WESTMAN CHAMPLIN & KELLY, Suite 1600 - International Center, 900 South Second Avenue, Minneapolis, MN, 55402-3312, US

(21) Appl. No.: 10/087,708

(22) Filed: Mar. 1, 2002

(51) Int. Cl. G01N 27/00

(52) U.S. Cl. 436/149; 436/150; 436/124; 436/125; 436/163; 422/50; 422/82.01; 422/82.02

(57) ABSTRACT

A chemical sensing system senses a concentration of a chemical of interest in a fluid. A portion of the chemical of interest diffuses across a barrier into an electrolyte. The barrier can be one or more polymeric hollow fibers. Electrodes or other sensing devices are disposed within the electrolyte. The electrolyte is selected such that it undergoes regenerative chemical reaction as it is exposed to the chemical of interest and the electrodes. The concentration of the chemical of interest can be determined by measuring a property of the electrolyte, such as current flowing through the electrolyte.

### BACKGROUND OF THE INVENTION

This invention relates to analyzers that detect the concentration of one or more chemicals of interest. These analyzers can be used in a variety of fields such as the analytical, medical, and process control fields.

There are a number of known systems and techniques that can be used for detecting and analyzing individual chemical species. Generally, each analyzer and/or method used therewith, has associated strengths and weaknesses.

One example of known chemical species analysis is spectrometry. In general, spectrometry includes the detection of absorption signatures and/or the detection of atomic emission spectra. Generally, traditional absorption spectrometry involves the use of reagents that combine with a target chemical species producing a chemical compound that has known absorption characteristics. While some spectrometry methods are known wherein the use of reagents is not required, spectrometry in general involves relatively complex analyses. For example, a given compound or compounds may have a complex spectrographic signature which must be analyzed using complex algorithms and data intensive operations. Thus, while spectrographic techniques for chemical species analysis are known, they are generally disfavored techniques for relatively simply detection of a single chemical species.

Another type of sensor that is often used to measure chemical species is the “Clark cell.” This type of sensor can be used to selectively detect one or more chemical species of interest. Generally, a gradient of concentration or partial pressure of the chemical of interest, frequently but not necessarily a gaseous substance, such as molecular oxygen, hydrogen, ozone, carbon dioxide, etc., is established across a membrane located between the fluid and the interior of the sensor. The interior of the sensor contains an electrolyte and two or more electrodes. The concentration of the chemical of interest is determined by its interaction with the electrolyte and the resultant change in electrical characteristics between the electrodes. Clark cells suffer from electrolyte depletion limitations. Further, known Clark cells generally provide a relatively small surface area to the sample liquid resulting in a relatively large cell reaction time.

Another example of a known device is manufactured by Rosemount Analytical Inc. under the trade designation Model SCS921 Total Chlorine Monitoring System. This system is often used for determining the concentration of an analytical species of interest, such as chlorine, in a fluid sample. The SCS921 uses amperometric measurement to determine chlorine concentration in a fluid sample. Because no single sensor can generally detect chlorine in all its combinations, the chlorine is first converted into a form that the sensor can measure. A conditioning system does this by continuously adding a buffered reagent (potassium iodide) to the sample. Free and combined chlorine in the sample convert the iodide to iodine. An amperometric sensor then measures the concentration of iodine and sends a signal to an analyzer. The analyzer displays the concentration of total chlorine. While this device provides highly efficient chlorine analysis and is generally well accepted, it is noted that the reagent (potassium iodide) is consumed during operation.

While a number of advancements have been made in the art of chemical species analyzers, there is a continuing need to provide a chemical species analyzer with the simplicity and accuracy of a system such as the Rosemount Model SCS921 that does not consume a reagent during operation and provides a relatively quick response. Such a system would allow unattended operation for longer periods of time because the reagent supply would not need to be refilled. Further, the system would enjoy the advantages of the current SCS921 in that quantitative analyses of a chemical species of interest can be derived relatively easily and without the use of complex algorithms and computational overhead.

### SUMMARY OF THE INVENTION

A chemical sensing system senses a concentration of a chemical of interest in a fluid. A portion of the chemical of interest diffuses across a barrier into an electrolyte. The barrier can be one or more polymeric hollow fibers. Electrodes or other sensing devices are disposed within the electrolyte. The electrolyte can be selected such that it undergoes regenerative chemical reaction as it is exposed to the chemical of interest and the electrodes. The concentration of the chemical of interest is determined by measuring a property of the electrolyte, such as current flowing through the electrolyte.

### BRIEF DESCRIPTION OF THE DRAWINGS

FIG. 1 is a diagrammatic view of an analytical instrument in accordance with an embodiment of the invention.

FIG. 2 is a diagrammatic view showing further details of an embodiment of the invention.

FIG. 3 is a graph of sensor response to chlorine concentration changes.

FIG. 4 is a graph of chlorine concentration as measured in parts per million (ppm) and microamps versus time in minutes.

### DETAILED DESCRIPTION OF THE PREFERRED EMBODIMENTS

Embodiments of the present invention utilize a hollow fiber diffusion membrane and optionally an electrolyte that is selected based upon the anticipated species of interest such that a regenerative synergy can be achieved during operation. Although the present invention will be described with respect to a chlorine analyzer and the preferred chemistry associated therewith, those skilled in the art will recognize that the invention itself is broader and readily applicable to other fields of chemistry.

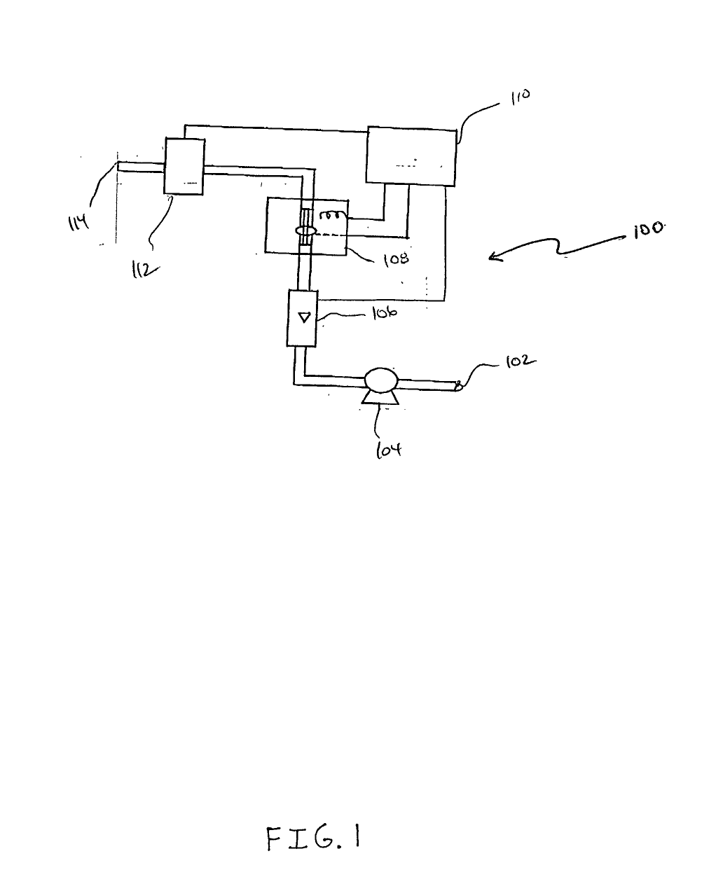

FIG. 1 is a diagrammatic view of a chemical species analyzer in accordance with an embodiment of the present invention. Analyzer 100 includes inlet 102, pump 104, flowmeter 106, cell 108, transmitter 110, pH sensor 112, and outlet 114. The sample stream is received at inlet 102 and provided to pump 104. Pump 104 is preferably a peristaltic pump that conveys the sample through flowmeter 106 to cell 108. Flowmeter 106 provides an indication to transmitter 110 of the magnitude of sample stream flowing through flowmeter 106. In one embodiment, the sample stream includes various forms of chlorine, including free and combined chlorine. Forms of combined chlorine include, but are not limited to, hypochlorous acid, hypochlorite ion and monochloramine.

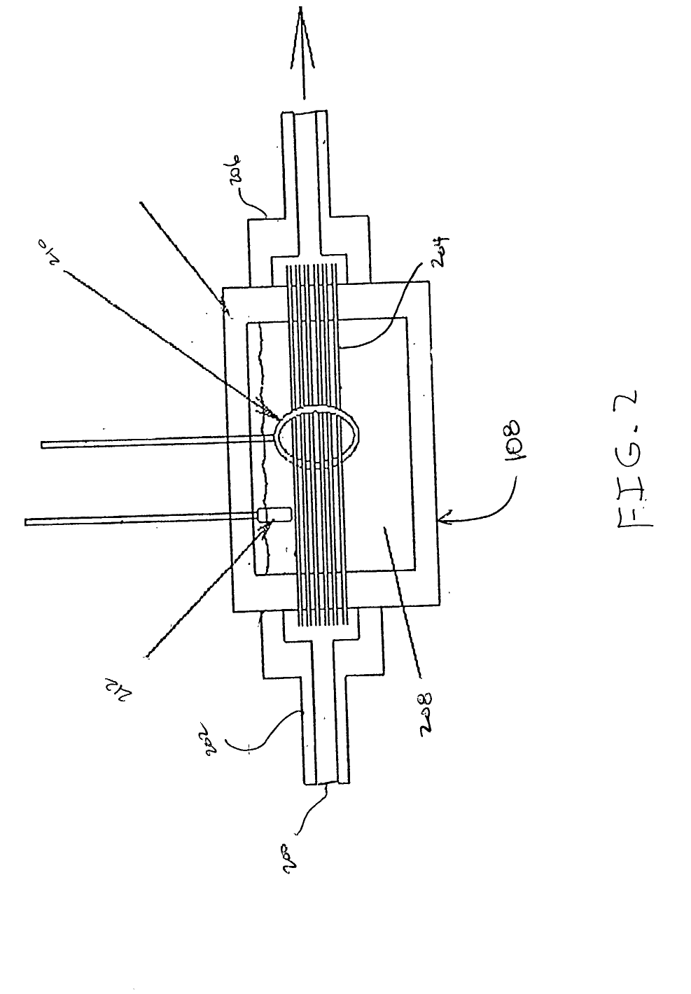

The sample stream flows through cell 108, which cell generates a response based upon the quantitative presence of a chemical species of interest. The operation of cell 108 will be described in greater detail with respect to FIG. 2. The sample then flows from cell 108 through pH sensor 112 and finally through outlet 114. Sensor 112 measures a pH of the sample flow exiting cell 108 and provides an indication of the pH to transmitter 110. System 100 is particularly adapted for monitoring the quantitative fluctuations of the chemical species of interest. For example, since chlorine is often used to disinfect water supplies, it is generally monitored continuously in order to continually gauge the efficacy of water treatment.

FIG. 2 is a diagrammatic view of cell 108 shown in greater detail. Cell 108 includes inlet 200 which is fluidically coupled to flowmeter 106 (illustrated in FIG. 1) to receive a sample stream containing a chemical species of interest. Inlet 200 is coupled to inlet body 202. Inlet body 202 fluidically couples inlet 200 to one or more fibers 204. Sample stream passes through fibers 204 and enters body outlet 206. While the sample stream passes through fibers 204, a relatively small amount of sample fluid diffuses across small pores in each individual fiber wall. By using a relatively large number of fibers, the surface area for diffusion is significantly increased. Preferably, the pores are sized to provide a molecular weight cutoff (MWCO) between about 1,000 and about 1,000,000. In the preferred embodiment, each of fibers 204 is a polymeric hollow fiber designed to sustain an internal pressure of approximately 30 PSIG. Examples of suitable polymers include polysulfone, polyethylene, cellulose esters, PVDF and polypropylene. The relative sizing of hollow fibers 204 and the number of fibers themselves are preferably selected to ensure that an adequate supply of sample flows therethrough. In one embodiment, fibers 204 were approximately 38 mm long with one third of their length exposed to electrolyte 208. The sample diffusing across the walls of fibers 204 passes into electrolyte 208. In preferred embodiments of the present invention, electrolyte 208 has a chemical composition that is selected based upon the chemical species of interest such that a regenerative effect is achieved. This regenerative effect will be illustrated in the following chemical example but is by no means limited to the following example.

As described above, one common use for a chemical species analyzer is that of monitoring chlorine and chlorine compounds. In such instance, one suitable electrolyte 208 is potassium bromide (KBr). More specifically, it has been found that the action of potassium bromide is facilitated if the pH thereof is maintained at a level below approximately 4. The potassium bromide electrolyte will react with all forms of chlorine diffusing across the walls of hollow fibers 204 to form bromine, potassium chloride and ammonia as set forth below in the following equations.

2Br⁻+HOCL+2H⁺=Br₂+HCl+H₂O

and/or

2Br⁻+NH₂Cl+2H⁺=Br₂+HCl+NH₃

or

2Br⁻+O₃+2H³⁰=Br₂+O₂+H₂O

The bromine (Br₂) is reduced at the cathode into 2Br⁻+2e₋ electrons. This is the reaction that generates electrical current between the cathode and the anode thereby providing an indication of bromine concentration and thus chlorine concentration. Since the end result of the reduction of bromine is bromide, which is then used to react with additional chlorine, the electrolyte 208 can be considered regenerative. In this example, bromine can be considered an intermediate species since it is used for analysis and is subsequently converted back to bromide ions. Unlike many known chlorine analysis systems that provide a reagent into the sample stream, no such reagent is required with embodiments of the present invention. Those skilled in the art will appreciate that over time, a quantity of potassium chloride may accumulate as well as other substances, eventually requiring replacement or rejuvenation of electrolyte 208. However, it is believed that the maintenance required for such operations is vastly reduced from that of the known systems.

As the bromine, in the example discussed, reacts upon cathode 210, a current is generated between cathode 210 and anode 212. Measuring the current between cathode 210 and anode 212 is simply one way in which a property of cell 108 can be obtained relative to the species of interest. Other techniques including measuring the voltage across cell 108 or employing optical techniques may also be used. However, the combination of an electrolyte 208 matched to the chemical species of interest in combination with an amperometric sensor using a hollow fiber diffusion membrane is preferred.

As illustrated in FIG. 2, cathode 210 is preferably located proximate fibers 204. Cathode 210 is illustrated encircling the bundle of fibers 204. This configuration provides a relatively large surface area of cathode 210 upon which the bromine, in the example discussed, can reduce. It is believed that the proximity of cathode 210 to fibers 204 plays an important role in the sensitivity of cell 108. Thus, in a preferred embodiment, placing cathode 210 as close as practically possible to fibers 204 will provide the best sensitivity. In a preferred embodiment, electrodes 210 and 212 are constructed from gold. However, those skilled in the art will recognize that other suitable materials may be substituted therefor.

Electrodes 210 and 212 are coupled to transmitter 110 which is adapted, via known techniques, to measure an electrical parameter related to cell 108 and provide an indication of bromine concentration and thus chlorine concentration. Additionally, transmitter 110 preferably includes suitable electronics to receive the flowmeter output from flowmeter 106 and pH output from pH detector 112 in order to characterize the response of cell 108 across varying flows and pH levels. Further still, transmitter 110 can be equipped with suitable communication circuitry to communicate an indication of the species of interest to a controlling via known methods, such as 4-20 miliamp, Highway Addressable Remote Transducer (HART®), and FOUNDATION™ fieldbus.

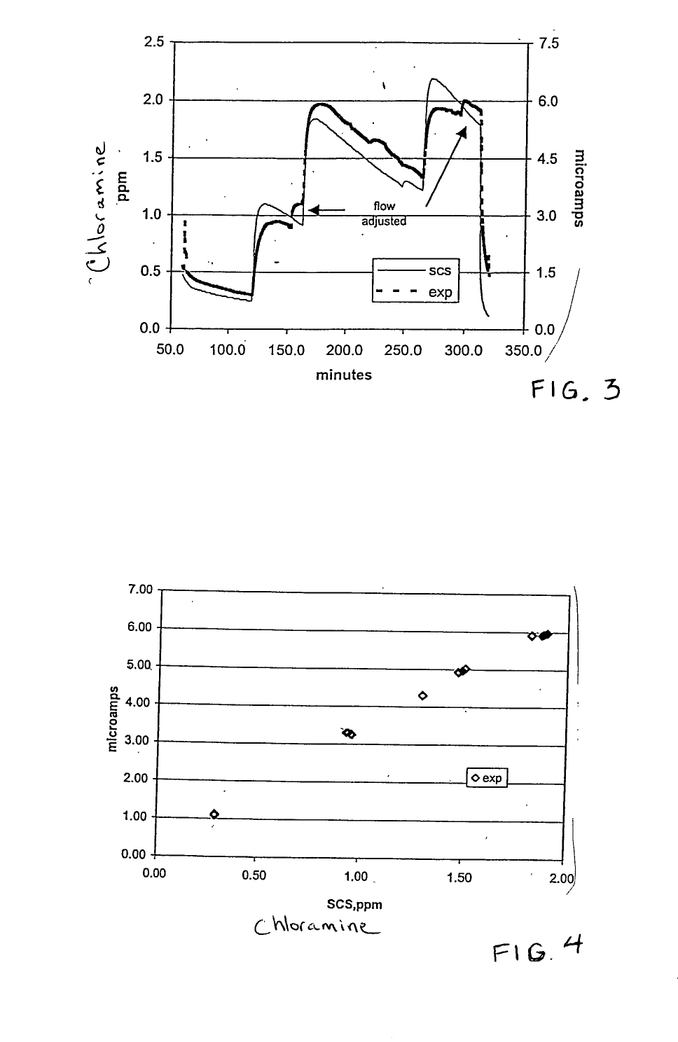

FIG. 3 is a graph of chloramine concentration as measured in parts per million (ppm) and microamps versus time in minutes. FIG. 3 shows that a sensor in accordance with an embodiment of the invention produced measurements similar to another sensor of conventional design (SCS) placed in the same flow of process fluid. FIG. 4 is a graph of microamps versus (SCS) concentration in ppm. FIG. 4 shows that the output current from a sensor, built in accordance with an embodiment of the invention, produced substantially linear measurements over the range of test values.

Although the present invention has been described with reference to present embodiments, workers skilled in the art will recognize that changes may be made in form and detail without departing from the spirit and scope of the invention. For example, although the operation of cell 108 was described as utilizing sample flow in one direction, the opposite direction or both directions could be used.

What is claimed is:

1. A chemical sensor for measuring a chemical of interest, the sensor comprising:
a body having an inlet and an outlet, the body defining a chamber therein, the chamber being at least partially filled with an electrolyte;
at least one fiber defining a flow passageway in fluidic communication with the inlet and the outlet, the at least one fiber being adapted to pass a portion of the chemical of interest into the electrolyte; and
a plurality of electrodes disposed in the electrolyte.

2. The sensor of claim 1, wherein the electrolyte is regenerative.

3. The sensor of claim 1, wherein the chemical of interest is chlorine and the electrolyte is potassium bromide.

4. The sensor of claim 1, wherein at least one of the electrodes is proximate the fiber.

5. The sensor of claim 1, wherein at least one of the electrodes encircles the fiber.

6. The sensor of claim 1, wherein the fiber includes at least one polymeric hollow fiber.

7. The sensor of claim 1, wherein a current is measured through the plurality of electrodes.

8. The sensor of claim 1, wherein a voltage across the plurality of electrodes is measured.

9. An instrument for measuring a chemical of interest, the instrument comprising:
an electrochemical sensor having a regenerative electrolyte disposed therein;
at least one hollow fiber adapted to carry sample fluid through the electrochemical sensor; and
a transmitter coupled to the electrochemical sensor, the transmitter adapted to calculate a concentration of the chemical of interest sensed by the electrochemical sensor.

10. The instrument of claim 9, and further comprising a flowmeter fluidically disposed in series with the electrochemical sensor, the flowmeter coupled to the transmitter, and wherein the transmitter further calculates concentration based at least in part upon a flow signal from the flowmeter.

11. The instrument of claim 10, and further comprising a pH sensor fluidically disposed in series with the electrochemical sensor and coupled to the transmitter, wherein the transmitter further calculates concentration based at least in part upon a pH signal from the pH sensor and the flow signal from the flowmeter.

12. The instrument of claim 9, and further comprising a pH sensor fluidically disposed in series with the electrochemical sensor and coupled to the transmitter, wherein the transmitter further calculates concentration based at least in part upon a pH signal from the pH sensor.

13. A method of measuring a concentration of a chemical of interest, the method comprising:
passing a quantity of a sample fluid through a hollow fiber having a porous wall;
diffusing a portion of the sample fluid across the porous wall into an electrolyte; and
measuring an electrical parameter of the electrolyte with a plurality of electrodes disposed within the electrolyte.

14. The method of claim 13, wherein the electrolyte is regenerative.

15. The method of claim 13, wherein the porous wall is a portion of a polymeric hollow fiber.

16. The method of claim 13, wherein the electrical parameter includes a current flowing through the plurality of electrodes.

17. The method of claim 13, wherein the electrical parameter includes a voltage across the plurality of electrodes.
